(19) United States
(12) Patent Application Publication
(10) Pub. No.: US 2006/0165926 A1
(43) Pub. Date: Jul. 27, 2006

(54) Medical devices including nanocomposites

(76) Inventor: Jan Weber, Maple Grove, MN (US)

Correspondence Address: FISH & RICHARDSON PC, P.O. BOX 1022, MINNEAPOLIS, MN, 55440-1022, US

(21) Appl. No.: 11/044,376

(22) Filed: Jan. 27, 2005

(51) Int. Cl. B32B 27/32

(52) U.S. Cl. 428/35.2; 428/34.1; 428/35.7; 428/36.9

(57) ABSTRACT

A medical device includes a component having a composite. The composite includes a matrix material and particles having molybdenum and sulfur. The particles can further include iodine.

### TECHNICAL FIELD

The invention relates to medical devices including one or more components comprised of one or more nanocomposite materials. By utilizing nanocomposites in the manufacture of the medical devices, certain properties of the nanocomposites may be exploited in ways particularly advantageous in the medical device industry.

### BACKGROUND

The medical device industry is but one example of an industry where the products or devices produced and used therein requires the products to exhibit a diverse array of properties. Transluminal medical devices are one example. Such devices are typically introduced into the vasculature of a patient at a point remote from the treatment site, a procedure that can be uncomfortable for the patient. In order to perform acceptably, and to minimize the trauma to the patient, transluminal devices typically exhibit diverse, and at times divergent, performance characteristics. For example, many such devices desirably exhibit good maneuverability so as to be manipulated to and/or inserted at a location requiring treatment, but yet sufficiently strong in the longitudinal direction so as not to buckle or kink when being so manipulated. In fact, many medical devices require a combination of these, and other, properties such as strength, thermal stability, structural stability, flexibility, opacity, radio-opacity, storage stability, lubricity, stability to sterilization treatment, etc., in order to be effective for their intended purpose.

Material selection is thus very important to the therapeutic efficacy of many medical devices since the properties of the materials used often dictates the properties of the overall device. However, the range of properties available from one, or even a combination of, material(s) is often not as broad as would be desired in medical device applications. As a result, many medical devices need to be manufactured from a combination of materials, processed in a specific manner, coated, or subjected to other treatments, in order to exhibit the desired and/or required characteristics.

Thus, there is a continuing need in the medical device industry to develop or discover additional materials that exhibit the range of properties required for a medical device.

### SUMMARY

The present invention provides medical devices comprising composite (e.g., nanocomposite) materials. Utilization of nanocomposites for medical devices can provide the devices with many, or all, of the diverse properties often desirable in the same. That is, inasmuch as such devices often desirably exhibit a vast number of often times divergent properties, it can be difficult to manufacture such devices without utilizing an extensive number of materials and processing techniques. As described herein, medical devices can be produced with a desired array of properties using a lesser amount of materials and/or processing techniques, or medical devices can be produced wherein one or more of the properties are enhanced.

In one aspect, the invention features a medical device comprising at least one nanocomposite material. The nanocomposite material(s) may desirably be employed to produce one or more components of the device, or may be utilized to produce the device in total. The nanocomposite is desirably comprised of a matrix material and at least one plurality of filler particles. In some embodiments, the nanocomposite may comprise a matrix including a first plurality of filler particles comprised of a first material and at least one other plurality of filler particles comprised of a second material.

Also provided is a method of making the inventive medical devices wherein the method comprises selecting the nanoparticulate filler, selecting the matrix material, preparing a nanocomposite from the filler and matrix material, and preparing at least a component of the medical device from the nanocomposite material. Exemplary medical devices include balloons, catheters, filters and stent delivery systems such as disclosed in U.S. Pat. Nos. 5,843,032; 5,156,594; 5,538,510; 4,762,129; 5,195,969; 5,797,877; 5,836,926; 5,534,007; 5,040,548; 5,350,395; 5,451,233; 5,749,888; 5,980,486; and 6,129,708, the full disclosures of each of which are hereby incorporated by reference herein for all purposes.

The medical devices can have enhanced properties relative to, or properties absent from, a corresponding medical device not comprising a nanocomposite material. As a result, the medical devices can provide certain advantages in their use. In this regard, the invention also features a method of treatment or diagnosis comprising bringing a medical device into therapeutic contact with a body to be treated or diagnosed, wherein the medical device comprises at least one nanocomposite material.

### DESCRIPTION OF DRAWINGS

FIG. 1 is a longitudinal cross-sectional view of the distal end of a medical device; and

FIG. 2 is a transverse cross-sectional view of the device shown in FIG. 1, taken at line 2-2.

### DETAILED DESCRIPTION

The embodiments described below are not intended to be exhaustive or limiting. Rather, the embodiments are described so that others skilled in the art understand the principles and practices of the present invention.

The invention features medical devices including at least one component comprised of at least one nanocomposite material. The material can be particularly advantageous when applied to medical devices contemplated for either temporary or permanent treatment of the heart and/or circulatory system. For example, for treatment devices (such as an angioplasty catheter, angiography catheter, stent delivery system, etc.) the device desirably provides sufficient “pushability” that force applied at the proximal end is transmitted to the distal end to guide the distal end to the desired site. Such devices are also desirably ‘trackable’ so that a positional movement, as to the right or the left, upward or downward, exerted by the operator at the proximal end translates to the desired motion at the distal end. Such devices are also desirably flexible enough so that when traversing a narrow and often tortuous space to get to the desired sight, the device does not cause substantial injury to the surrounding tissue. Finally, it is often desired that the outer surface, or inner surface of these devices be sufficiently lubricious so as to be easily passed over a guidewire and through the body to the desired site.

Devices intended to be used for a substantially permanent treatment have a corresponding number of desirable and yet diverse properties. For example, devices intended for implantation into the heart or vasculature to repair or replace certain parts thereof, such as artificial heart valves, artificial veins and arteries, or stents, desirably exhibit robust mechanical strength, and are yet flexible enough, to withstand the periodic yet continual contractual environment in which they must not only exist but function. The devices may also desirably be substantially nonthrombogenic due to the extended period of time these devices are contemplated to be resident within the body. Furthermore, in certain applications, such devices may desirably be biodegradable.

In order to achieve a combination of desired properties, more than one type of material is often employed in the construction of medical devices. For example, reinforcing filler particles can be added to a matrix material to form a composite material having a desired modulus, i.e., by acting as stress transmission elements and/or by concentrating or increasing the strain within the matrix material. Conventionally, the filler particles used in such composites are comprised of glass fibers, aggregates of amorphous or graphitic carbon, metal flakes, etc, and are at least about I micrometer in diameter in their largest dimension or larger. While such composite materials are useful in many medical device applications, the tolerances for many other medical device applications may not accommodate conventional, large size, filler particles.

Recently, a new class of filler particles has been described having at least one dimension less than about I micrometer. Filled polymer systems which contain such nanostructured particles have been termed nanocomposites. These new materials can provide many advantages in the production of medical devices. The use of nanocomposite materials in the manufacture of the medical devices may provide the ability to control the modulus of a nanocomposite material while not affecting the processability thereof. Further, the use of nanocomposites may provide these advantages without substantially negatively impacting the compatibility between the nanocomposite and other materials that may be used in the manufacture of the medical device. Finally, by combining nanocomposites with other non-composite materials, it may be possible to control the directionality of change in the physical properties.

In addition to tailoring physical properties in small dimensions, nanocomposites may offer other significant advantages in medical device applications. For example, since in many cases the size of the nanofiller particle is smaller than the wavelength of visible light, it is possible to use nanocomposite materials to achieve the aforementioned advantages, while yet providing a transparent material. Such transparent nanocomposite materials could be useful, for example, to provide X-ray radiopaque materials that are optically clear. Other advantages to the use of nanocomposites in medical devices may include effects such as lowering the coefficient of friction, providing biocompatibility, and imparting biodegradability, to name a few.

Also, and without being limited to a particular theory, it is believed that because of the size of the nanoparticles, there is increased surface area contact between the filler particles and the matrix material in a nanocomposite as compared to a traditional filled polymer. This effect may be further enhanced by utilizing filler particles that are not only smaller than traditional filler particles, but also, that have high aspect ratios, i.e., a large ratio of their lateral dimension as compared to their thickness. Properties as good or better may thus be achieved in a nanocomposite as compared to the corresponding traditional filled polymer, while utilizing less filler material. Not only are performance and quality control significantly enhanced, cost savings can be seen that can be an important advantage in many medical device applications.

The term ‘nanocomposite’, as used herein, generally refers to a composite material comprising a matrix material and a plurality of filler particles, wherein the filler particles are smaller than those utilized in conventional filled composites. More particularly, the term “nanocomposites” includes a matrix material comprising at least one plurality of filler particles having at least one dimension less than about 1000 nm in size. In some embodiments, the filler particles are between about 1 nm and 100 nm. Advantageously, nanocomposite materials can be engineered so that the nanocomposite exhibits the same properties as the matrix material to an enhanced degree and/or exhibits properties in addition to those exhibited by the matrix material alone. Utilizing nanocomposite materials in the manufacture of one or more components of medical devices may allow certain properties of the nanocomposites to be exploited in ways particularly advantageous in the medical device industry.

It is believed that the composite may be particularly advantageous when utilized in medical devices contemplated to be brought into therapeutic contact with a body, i.e., devices contemplated to be introduced into the body, either temporarily or permanently, for the purpose of effectuating a treatment or diagnosis thereof. Such devices find use in, e.g., urinary, cardiovascular, musculoskeletal, gastrointestinal, or pulmonary applications. Medical devices useful in urinary applications include, for example, catheters, shunts, stents, etc. Exemplary medical devices useful in cardiovascular applications include stents, angiography catheters, coronary or peripheral angioplasty catheters (including over the wire, single operator exchange or fixed wire catheters), balloons, guide wires and guide catheters, artificial vessels, artificial valves, filters, vascular closure systems, shunts, etc. Musculoskeletal medical devices include, for example, artificial ligaments, and prosthetics. One example of a medical device useful in a gastrointestinal application is a shunt. Pulmonary medical devices include prosthetics, as one example.

One example of a particular application is that of transluminal medical devices. Such devices include, e.g., catheters (e.g., guide catheters, angioplasty catheters, balloon catheters, angiography catheters, etc.) shunts, stents and stent delivery systems (e.g., self-expanding and balloon expandable), filters, etc. These devices often include extruded components made up of one, two, three, or more layers of materials. In some embodiments, such devices include at least one nanocomposite material. That is, certain components of the device can include nanocomposite and non-nanocomposite materials. If multiple layers are used, at least one layer can be a nanocomposite material. The number and organization of the layers can be chosen to effectuate and/or to provide properties desired in the device. Further, in some embodiments, the quantity of filler particles of the nanocomposite material can vary at different regions of the nanocomposite. Such an alteration in the filler density can, for example, provide a device that has varying properties, such as flexibility, along its longitudinal axis.

In one exemplary embodiment, the medical device can be a catheter shaft such as for an angiography system, angioplasty balloon, guide catheter, or stent delivery system. Such devices often include multiple lumens in a side-by-side or coaxial configuration. Coaxial configurations generally have more than one lumen, wherein the lumens are typically fixed relative to one another and may be provided as coextruded single components, or may be separately extruded and then assembled by any conventional construction method to provide a multiple lumen structure. Any of, or all, of the tubular components providing such a multiple lumen structure can be formed from a nanocomposite material. In some embodiments, the tubular component can be comprised of a plurality of layers wherein at least one layer of the tubular wall is a nanocomposite material. In such devices, the number and organization of the layers can be chosen to effectuate and/or provide the properties desired in the multilayer tubular component. Further, the dimensions of the device can be varied. For example, the layers of a multilayered tubular wall can have a diverging or converging taper from the proximal end to the distal end of the wall.

As but one particular example of the embodiment wherein the medical device is a catheter shaft, conventionally reinforced with steel braiding, the catheter shafting may alternatively (or additionally) and advantageously be prepared utilizing a nanocomposite comprising, for example, ceramic nanofibers as the filler particles. Inasmuch as such a nanocomposite can be processed using normal extrusion processes, intermittent extrusion and/or multi-layer extrusion can be used to selectively include the ceramic nanofibers, in order to further selectively stiffen areas of the shaft. Further advantageously, the ceramic nanofibers may be oriented if desired by employing rotating or counter-rotating extrusion, which orientation can provide enhanced torque performance of the shaft. If such orientation is not desired, ultrasonic vibrations can be introduced into the extrusion process in order to obtain a more randomized ceramic nanofiber orientation. In addition to these processing advantages, such shafting, while providing catheter shafting with a desired degree of reinforcement, would also be useful in MRI applications.

The nanocomposite material to be used in the medical devices is not particularly restricted. Rather, any nanocomposite that can be engineered to display at least one of the properties desired in the desired medical device can be used. As is the case with the overall nanocomposite material, the material(s) that may be used as either the matrix material or the filler particle material is not restricted. Rather, nanocomposites to be utilized as disclosed herein can be comprised of any matrix material, or combinations thereof, and at least one plurality of filler particles.

The selection of the particular matrix material(s) and filler particle(s) for use in the nanocomposite(s) will depend on the intended use of the medical device into which the nanocomposite will be incorporated and desired properties of a device to be used in that manner. The matrix material and filler particle material(s) may then be chosen, e.g., to either enhance a property of the matrix material or to add a property otherwise absent from the matrix material so that selected properties are exhibited by the nanocomposite, which may not be exhibited by the matrix material alone. Such an enhancement or addition can provide the overall device with enhanced performance characteristics, or can provide greater quality control or enhanced tolerances in the manufacture of such devices.

Generally speaking then, the matrix material may be any material suitable, or later determined to be suitable, for use in such a medical device. The matrix material may be any material that is historically or currently utilized, or contemplated for future use, in a corresponding medical device not comprising a nanocomposite component. The matrix material may be comprised of organic, inorganic or hybrid organic/inorganic materials. Additionally, the matrix material may be a single material or a combination of materials, e.g., the matrix material may be a metal alloy, copolymer or polymer blend.

Exemplary matrix materials include, for example, polymers, such as thermoplastics and thermosets. Examples of thermoplastics suitable for use as a matrix material include, for example polyolefins, polyamides, such as nylon 12, nylon 11, nylon 6/12, nylon 6, and nylon 66, polyesters, polyethers, polyurethanes, polyureas, polyvinyls, polyacrylics, fluoropolymers, copolymers and block copolymers thereof, such as block copolymers of polyether and polyamide, e.g., Pebax®; and mixtures thereof. Representative examples of thermosets that may be utilized as a matrix material include elastomers such as EPDM, epichlorohydrin, nitrile butadiene elastomers, silicones, etc. Conventional thermosets such as epoxies, isocyanates, etc., can also be used. Biocompatible thermosets may also be used, and these include, for example, biodegradable polycaprolactone, poly(dimethylsiloxane) containing polyurethanes and ureas, and polysiloxanes.

Similarly, the filler particles may be comprised of any material suitable, or later determined to be suitable, for use in a medical device as a filler. Desirably, the filler particles comprise a material capable of at least minimally altering the physical, mechanical, chemical, or other, properties of a matrix material when incorporated therein. The filler particles may comprise any material that has been historically used, is currently used, or is contemplated for use, as a conventionally sized filler material in a medical device. Further, the filler particles may be comprised of organic, inorganic or hybrid organic/inorganic materials.

Exemplary filler particles include, among others, synthetic or natural phyllosilicates including clays and micas (that may optionally be intercalated and/or exfoliated) such as montmorillonite (mmt), hectorites, hydrotalcites, vermiculite, and laponite; monomeric silicates such as polyhedral oligomeric silsequioxanes (POSS) including various functionalized POSS and polymerized POSS; carbon and ceramic nanotubes, nanowires and nanofibers including single and multi walled fullerene nanotubes, silica nanogels, and alumina nanofibers; metal and metal oxide powders including aluminum oxide (Al₂O₃), titanium oxide (TiO₂), tungsten oxide, tantalum oxide, zirconium oxide, gold (Au), silver (Ag), platinum (Pt) and magnetic or paramagnetic powders such as neodinium iron boron, superparamagnectic ferrite oxide (Fe₃O₄) or superparamagnetic maghemite (Fe₂O₃); organic materials, including temperature sensitive polymers such as polyvinylpyrrolidone and n-isopropylacrylamide copolymers or blends, and poloxamer. Biodegradable polymers may also be used, may be magnetized, if desired, and include for example, poly(lactic)acid, polysaccharide, and polyalkycyanoacrylate.

Other examples of filler particles include those that include molybdenum (Mo), sulfur (S) and optionally iodine (I). Specific examples of these materials include single-walled or multiwalled molybdenum sulfide (e.g., MoS₂) nanotubes, doped MoS₂ nanotubes (such as lithium doped MoS₂ nanotubes), MoS₂₋ₓ nanotubes, Mo₆S₃I₆ solid (i.e., not hollow) nanowires, MoS₂I_{1/3} nanotubes, and Mo₆S₄I₆. Synthesis and characterization of these materials are described in, for example, Vrbanic et al., Nanotechnology, 15, (2004) 635-638; Remskar et al., Science, Vol. 292 20 Apr. 2001 479-481; Mihailovic, Phys. Rev. Lett., 90(14) 11 Apr. 2003 146401-1 to 146401-4; Tenne et al., Nature 1992, 360, 444; Margulis et al., Nature 1993, 365, 113; Math et al., Adv. Mater. 2001, 13, 283; Drobot et al., Russ. J. Inorg. Chem. 1985 30, 949; and Dominko et al., Adv. Mater. 2002, 14 (21) 1531, all hereby incorporated by reference. Without wishing to be bound by theory, it is believed that molybdenum sulfides and molybdenum sulfur iodides have one or more properties that are well suited for medical device applications. For example, the materials include molybdenum and possibly iodine, which can enhance the radiopacity of the filler particles and thus the medical device in which the particles are included. The enhanced radiopacity of the particles may allow a small amount of particles to be used to provide the medical device with a targeted radiopacity; as a result, the physical properties of the matrix material may not be substantially altered by the particles, if such a result is desired. Or, a substantial amount of the particles can be used to both strengthen the composite material and to enhance radiopacity. The Mo—S and Mo—S—I particles may have a large paramagnetic susceptibility that enhances the MRI visibility of the medical device. The Mo—S and Mo—S—I particles can be air stable and highly dispersable in the matrix material (e.g., the particles do not substantially clump together). As a result, the composite can be conveniently processed (for example, extruded without using stringent conditions). The high dispersability of the Mo—S and Mo—S—I particles allows the particles to modify the physical properties of the matrix material without using a substantial amount of particles (if desired), and/or without extensive grinding or compounding of the composite material to disperse the particles and/or remove clumping of the particles. Extensive grinding or compounding of the matrix material can reduce the molecular weight of the matrix material and reduce the strength of the matrix material.

There may be applications in which it is desirable to have a combination of more than one plurality of filler particles, so that each different plurality may be comprised of a different material. In this manner, a further enhancement of a single desired property, or a new property broadening the array of properties may be seen in the medical device prepared from such a nanocomposite. For example, it may be advantageous to prepare a nanocomposite from a polymeric matrix material, a first filler particle material that exhibits radio-opacity, and a second filler particle material that is influenced by magnetic fields. As a result, a medical device may incorporate more than one plurality of nanoparticulate filler particles, wherein each plurality may comprise a different material.

As mentioned above, the filler particles used in the nanocomposites can be comprised of any material utilized in a medical device as a conventionally sized filler. While such conventionally sized filler particles can range in size from several microns to several millimeters in size, the filler particles utilized in nanocomposites are desirably 1000 nm in the greatest dimension or less, for example, 750 nm or less, or 500 nm or less, for example, from about 1 nm to about 100 nm. It is believed that the smaller the particle, the more easily dispersed within the matrix material it will be, and as a result, in embodiments where a uniform dispersion is desired, the particles are 100 nm or less in the greatest dimension.

Further, the filler particles, whatever material they are comprised of, may be of any shape, i.e., the filler particles can be generally spherical, octagonal or hexagonal, or they may be in the form of nanotubes, nanobelts, nanofibers, nanowires, etc. However, and as is mentioned above, the dispersion of the filler particles within the matrix material, as well as the interaction of the matrix material and the filler particles, may be enhanced by increasing the surface area contact between the matrix material and the filler particles, and as such, filler particles having a high aspect ratio, i.e., a large ratio of their lateral dimension to their thickness, may be particularly advantageous. For example, and whatever the geometry of the filler particle, filler particles having aspect ratios of greater than 20:1 may be capable of promoting this increased dispersion and/or interaction between the filler particles and the matrix material. In some embodiments, the filler particles have aspect ratios of between 50:1 and 2500:1, for example, between 200:1 and 2000:1, such as, from 300:1 to 1500:1.

The amount of the filler particles, or combinations of filler particles comprised of different materials, to be incorporated into the matrix can vary depending on the desired properties exhibited by a particular medical device or medical device component. For example, enough of the particles may be included so that desired properties are at least minimally exhibited by the nanocomposite, but not so much of the filler particles are included so as to have a detrimental effect on the properties of the nanocomposite. While the particular range may vary depending on the filler particles and matrix material being utilized, nanocomposites exhibiting advantageous properties can be obtained by incorporating from about 0.005% to about 99% nanoparticles relative of the total final composition weight of the nanocomposite. In many embodiments, nanoparticles may be incorporated in an amount of from about 0.01% up to about 40% or 50% by weight of the nanocomposite. The nanoparticles can be incorporated in an amount of from about 0.1% to about 20% of the nanocomposite, for example, from about 1% to about 10% by weight of the nanocomposite.

The properties of the nanocomposites may be affected by compatibility of, and/or, the level and/or kind of interaction that occurs between, the filler particles and the matrix material of the nanocomposite. The compatibility of the filler particles and the matrix material may be minimal e.g., so that the interaction therebetween is limited to physical contact that occurs when the filler particles are dispersed within the matrix. Or, the compatibility may be such that the filler particles and the matrix interact physically, such as by chain entanglement of the filler particles with the matrix material. The filler particles and matrix material may also interact chemically, such as by the establishment of Van Der Waal's forces, covalent bonds or ionic bonds between the filler particles and the matrix material.

Any such compatibility, and the resulting interaction, can act to enhance the dispersion of the filler particles within the matrix material and/or to further enhance the properties of the nanocomposite as compared to a corresponding traditionally filled polymer. If this is the case, in some embodiments, the greater the compatibility and more or stronger the interaction, the greater the increased dispersion and/or enhancement. Therefore, in applications where such greater dispersion or further property enhancement is desirable, the compatibility of, and resulting interaction between, the filler particles with the matrix material can be encouraged or facilitated.

The compatibility of the filler particles and the matrix material can be enhanced, for example, by selection of the materials for use as the matrix or in the filler particles. That is, interaction between the filler particles and the matrix may be facilitated by selecting filler particles and matrix materials with compatible functional groups. If such compatible functional groups are not present, they can be provided by ‘functionalizing’ the filler particles or matrix material to provide compatible functional groups that can then interact with each other. Phyllosilicates, monomeric silicates and ceramics are just a few examples of materials suitable for use in the filler particles that may be advantageously functionalized to provide increased interaction between the filler particles and the matrix material.

For example, POSS monomers can be functionalized with, e.g., organic side chains to enhance compatibility with, e.g., polystyrene. The ceramic boehmite (AlOOH) already has many surface available hydroxyl groups and as such, may be further functionalized with, e.g., carboxylic acids, which in turn can be functionalized to interact with functional groups within the matrix material. Additionally, clays such as aluminosilicates or magnesiosilicates can be functinalized with block or graft copolymers wherein one component of the copolymer is compatible with the clay and another component of the copolymer is compatible with the polymer matrix. Or, clays such as montmorillonite may be functionalized with alkylammonium so that the clay is capable of interacting with a polyurethane, for example.

In those embodiments wherein the nanocomposite is desirably utilized in a multi-layered medical device, such as multi-layered tubing, and wherein at least two layers of the multi-layered device desirably comprise nanocomposite materials, functionalizers can be chosen for each layer that allow for the further optimization of the desirable properties of that layer, while potentially reducing compatibility issues between the layers. That is, in such embodiments, the at least two layers may comprise a nanocomposite material further comprising the same matrix material, or compatible matrix materials, and the same filler particles, but yet incorporating different functionalizers. The layers are thus chemically compatible and easily coprocessed, and yet, may exhibit different desirable properties.

In addition to functionalizing either or both the filler particles and/or matrix material, the compatibility of, and interaction between, the filler particles and matrix material can be enhanced by incorporating one or more coupling or compatibilizing agents into the nanocomposite to be used. Whereas functionalizers, discussed above, generally increase compatibility by modifying either or both of the matrix material and filler particles to include compatible chemical groups in their respective structures, coupling or compatibilizing agents need not do so in order to effectuate such interaction. That is, coupling/compatibilizing agents for use include any agent capable of enhancing compatibility and/or promoting interaction between the filler particles and the matrix without necessarily structurally modifying either or both the filler particles or matrix material. Such agents can be organic or inorganic.

The selection of these agents depend on the matrix and filler particle materials selected. Bearing this in mind, organic coupling agents can be both low molecular weight molecules and polymers. Examples of low molecular weight organic coupling/compatibilizing agents include, but are not limited to, amino acids and thiols. For example, 12-aminododecanoic acid may be used to compatibilize clay within a desired thermoplastic matrix. Examples of polymeric compatibilizers include functionalized polymers, such as maleic anhydride containing polyolefins or maleimide-functionalized polyamides. One example of a nanocomposite wherein the compatibility may be enhanced via the inclusion of such a polymeric compatibilizer is a polyolefin or nylon 12/montmorillonite nanocomposite, which may further include an amount of maleic anhydride functionalized polypropylene to compatibilize the matrix material and filler particles. Inorganic coupling agents may include, for example, alkoxides of silicon, aluminum, titanium, and zirconium, to name a few.

The amount of a coupling/compatibilizing agent used, if used at all, is desirably that amount which can at least marginally improve the compatibility of the filler particles and the matrix material so that at least a minimal enhancement of the dispersion of the filler particles within the matrix and/or the properties of the nanocomposite can be observed. Amounts of such agents may be within the ranges of from about 0.01% to about 10% by weight of the nanocomposite; for example, from about 0.05% to about 5.0%, such as from about 0.1% to about 1% by weight of the nanocomposite.

In addition to material selection, functionalizing and/or the use of compatibilizing agents as a means to promote interaction of the filler particles throughout the matrix material, the dispersion of the filler particles may be enhanced, if desired, by utilizing ultrasonic assisted extrusion and/or compounding. That is, by applying an ultrasonic vibration to the extruder die, the friction shear forces can be reduced, and the melt rendered more homogeneous. More particularly, such an extruder may include, e.g., an extruder head capable of extruding a polymer melt having an ultrasonic transducer operatively disposed thereto. The ultrasonic transducer is capable of transmitting ultrasonic waves to the extruder head, which waves may further advantageously be modulated to include at least one amplitude and modulation. In this manner, the waves provided to the extruder head may, if desired, be provided as substantially uniform vibrations to substantially the entirety of the extruder head.

An additional method for enhancing the dispersion of the filler particles throughout the matrix material includes dispersing the filler particles in a solvent, e.g., dimethylformamide, dichloroethylene, N-methyl-2-pyrrolidone and the like. Once so dispersed, the filler particles may be mixed with a similarly dissolved matrix material and sprayed onto a mandrel to produce a nanocomposite material with enhanced dispersion of the filler particles. Any other known techniques of enhancing the dispersion of filler particles within a matrix can also be utilized, if such an enhanced dispersion is desirable in the chosen application.

If dispersion of the matrix material and/or filler particles within a solvent is desired, either or both of the matrix material or filler particles may be functionalized in order to effectuate their dispersability within a desired solvent. That is, in addition to functionalizing either or both of the matrix material and/or filler particles so that they are more compatible with one another once formed into a nanocomposite material, either or both of the matrix material and/or filler particles may be functionalized to effectuate their dispersability within a solvent, in order to further enhance the dispersability of the filler particles within the matrix material. As but one example, single-walled carbon nanotubes may be functionalized with, e.g., carboxylic acid groups that are then subsequently converted to acyl chloride followed by conversion to an amide, to render the nanotubes disperable in organic solutions. As an additional example, functionalization with mono-amine terminated poly(ethylene oxide) or glucosamine can render single-walled carbon nanotubes soluble in aqueous solutions. Such functionalization of nanotubes to enhance their dispersion within aqueous or organic solvents is described in, e.g., U.S. Pat. Nos. 6,331,262 and 6,368,569, as well as Pompeo and Resasco, “Water Solubilization of Single Walled Carbon Nanotubes by Functionalization with Glucosamine” Nano Letters, 2(4), pp 369-373 (2002) and Bandyopadhyaya et al., “Stabilization of Individual Carbon Nanotubes in Aqueous Solutions”, Nano Letters, 2(1), pp 25-28 (2002), the entire disclosures of each being hereby incorporated by reference herein.

While it may be desirable in certain applications to increase the interaction between the nanoparticles and the matrix material, or between the nanoparticles and the device itself, extensive interaction between the nanoparticles themselves can be undesirable in certain applications. In particular, in applications where the nanoparticles desirably form a layer with a substantially uniform thickness, or where an otherwise substantially uniform dispersion throughout a matrix material or relative to a medical device is desired, any substantial agglomeration of the nanoparticles can be suboptimal. In such applications then, it may be advantageous or desirable to include a dispersant in solution with the nanoparticles prior to their dispersion within, or application to, the matrix material and/or the device.

As but one example, and in that embodiment wherein the nanoparticles desirably comprise carbon nanoparticles, such as carbon nanotubes, natural carbohydrates may be utilized to minimize or eliminate the interactions between the carbon nanotubes that may otherwise occur when the nanotubes are desirably solubilized. See, e.g., Dagani, “Sugary Ways to Make Nanotubes Dissolve”, Chemical and Engineering News, 80(28), pages 38-39; and Star et al., “Starched carbon nanotubes” Angewandte Chemie-International Edition, 41(14), pp. 2508 (2002), the entire disclosures of which are incorporated by reference herein.

In particular, in order to provide a solution of substantially non-aggregated carbon nanotubes that may then be mixed with a similarly dispersed matrix material or applied to a matrix material by spraying or dipping, the carbon nanotubes may be dispersed in an aqueous solution comprising such a natural carbohydrate. Illustrative examples of such natural carbohydrates include, but are not limited to, starches; gums, e.g., Gum arabic, and sugars gum. This solution can then be dried to form a substantially non-aggregated powder of carbon nanotubes and gum arabic that may then be compounded with a matrix material and processed into the desired medical device according to conventional techniques, or, the solution may be used to create uniform layers of substantially non-aggregated carbon nanotube fibers on the surface of a matrix material, on the surface of a component of a medical device, or onto substantially the totality of a surface of a medical device, in order to provide a medical device. If a uniform layer is desired, once the carbon nanotube/gum arabic solution has been prepared, the desired material may be coated with the solution by dipping the material in the solution and allowing the water to evaporate, leaving behind a substantially uniform layer of substantially non-aggregated carbon nanotubes. As discussed hereinabove, if desired, the carbon nanotubes can advantageously be functionalized prior to any such dispersion.

Such a layer of carbon nanotubes may be used as a tie layer between polymer layers of a medical device, e.g., by depositing the carbon nanotubes as described on at least one of the surfaces to be thermally bonded. Upon thermal bonding of the two layers, the interspersed tie layer of carbon nanotubes may provide additional reinforcement to the bond site. This advantageous technology may be applied to embodiments where a tie layer is desired between two layers of material wherein the second layer of material is applied to the first via welding, spraying, or multilayer extrusion and/or wherein electrical conductivity is desired. In such embodiments, the carbon nanotube/gum arabic solution may be applied to the first material and allowed to dry, and the second material subsequently applied according to the desired technology over the substantially uniform carbon nanotube layer. Further, the physical interaction between the carbon nanotubes and the matrix material can be supplemented by functionalizing the arabic gum with functionalizers as described above, providing a further opportunity to reinforce the bondsight.

In addition to the filler particles, the matrix material, and optionally, a coupling/compatibilizing agent, the nanocomposites can comprise any other materials utilized in a corresponding medical device not comprising a nanocomposite. For example pigments and/or whiteners, and/or conductive, magnetic and/or radiopaque agents could be provided in the nanocomposites, if desired. Also processing aids, such as plasticizers, surfactants and stabilizers, can be included in the nanocomposites. Such agents, the amounts in which they are useful, as well as the benefits that they provide, are well known to those of ordinary skill in the art.

One example of a class of stabilizers that may find use is that commonly referred to as radiation oxidative degradations, or “ROD” stabilizers. As the name suggests, these agents may assist a polymer within which they are incorporated to resist degradation that may otherwise occur upon exposure of the polymer to sterilizing radiation. Additionally, however, such stabilizers may also be useful in assisting a polymer to resist degradation that may otherwise occur during processing, such as during mixing and/or heating that may be required in order to adequately disperse nanoparticles throughout a matrix material.

Such ROD stabilizers may be antioxidants, particularly radical or oxygen scavengers. Mercapto compounds, hindered phenols, phosphites, phosphonites and hindered amine antioxidants are among the most effective such stabilizers. Specific examples of stabilizers are 2-mercaptobenzimidazole, trilauryl phosphite, IONOX 330, 2-mercaptobenzothiazole, N,N-di(.beta.-napthyl-p-phenylenediamine( (DPPD), SANTONOX R, SANTOWHITE powder, phenothiazine, IONOL, 2,6-di-t-butylcresol, N-cyclohexyl-N′-phenyl-p-phenylenediamine, nickel dibutyldithiocarbamate, IRGANOX 1010, .beta.-(3,5-di-t-butyl-6-hydroxyphe-nyl)propionate, 1,2,2,6,6-pentamethyl-4-stearoyl piperidine, and 2,2,6,6, tetramethyl-4-nitropiperidine. Further examples include butylated reaction product of p-cresol and dicyclopentadiene, substituted amine oligomers, N,N′-bis(2,2,6,6-tetramethyl4-piperidinyl)-1,6-hexanediamine, 2,4-dichloro-6-(4-morpholinyl)-1,3,5-triazine, and N,N′-hexamethylene-bis[3-(3,5-di-t-butyl4-hydroxyphenyl)propionamide]. Still further, transition metals or compounds thereof may function as ROD stabilizers, for instance iron, cobalt, nickel, ruthenium, rhodium, palladium, osmium, iridium, platinum, copper, manganese and zinc metal and compounds, as described in WO 99/38914, U.S. Pat. Nos. 5,034,252, and 5,021,515.

The ROD stabilizer may also be an oxygen scavenging polymer, such as the polyketone polymers described in WO 96/18686 of the formula 1 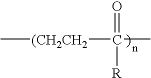
where R is H, an organic side chain or a silicon side chain, and n is a positive number greater than 2. Such polyketone ROD stabilizers may be employed in the thermoplastic composition in an amount of from 0.1 to about 10% by weight.

If their presence is desired, ROD stabilizers may be employed in the nanocomposites in any amount at least minimally effective in assisting in the resistance of the matrix material to degradation, e.g., in amounts of from about 0.01% to about 5%, or from about 0.1 to about 1%, for instance from 0.2% to 0.5%. The stabilizer can be compounded into the nanocomposite in the extrusion melt or in a separate compounding step prior thereto.

Many nanocomposites and nanoparticles are commercially available. Additionally, many methods of producing nanocomposites and/or nanoparticles are known, and any of these can be utilized to produce nanocomposites and nanoparticles for incorporation into the medical device. Many such methods are disclosed and described, for example, in “Nanocomposites 2001, Delivering New Value to Plastics”, Executive Conference Management, Jun. 25-27, 2001, Chicago, Ill., the entire disclosure of which is incorporated by reference herein.

Advantageously, and since the filler particles can have an impact on the properties exhibited by the nanocomposite by virtue of the dispersion of the filler particles within the matrix, the particular method utilized to prepare the nanocomposite can be selected to assist in the provision of medical device with the desired array of properties. That is, in certain medical device applications, it may be desirable to have the entirety of the medical device or medical device component exhibit the properties of the nanocomposite substantially uniformly throughout, or across the length of, the medical device. In such applications, it may be desirable to substantially uniformly distribute the filler particles throughout the matrix of the nanocomposite. In other applications, it may be desirable to have the entirety of the medical device or medical device component exhibit the properties of the nanocomposite, but at varying degrees throughout the device or component. In these applications, then, it may be desirable to vary the distribution of the filler particles throughout the matrix of the nanocomposite in a manner so that the desired varied properties are observed in the medical device or component.

For exemplary purposes only, then, processes for the production of such nanocomposites include polymerization of the matrix material in the presence of the filler particles, melt compounding of the matrix material with the filler particles, and in-situ formation of the filler particles, e.g., as may be provided by the adding a silane monomer to a block copolymer and then curing the silane to produce nanostructured silica filler particles relatively uniformly dispersed within the matrix material of the copolymer, to name a few. If a coupling/compatibilizing agent is to be used, it may be pre-coated onto the filler particles before compounding the filler particles with the matrix, or alternatively, the agents may be added during the nanocomposite formation process.

One of the advantages of the utilization of nanocomposites is that, at least as compared to traditionally filled polymers, nanocomposites are often more easily processed. As a result, once the nanocomposite has been prepared, it can be processed into the desired medical device by any method known to those of ordinary skill in the art, and the particular method chosen is not critical. There are a multiplicity of methods for the manufacture of medical devices that are thus appropriate, examples of which include, but are not limited to, foam processing, blow molding or film molding, sheet forming processes, profile extrusion, rotational molding, compression molding, thermoset pre-preg processes and reaction injection molding processes. Of course, the inventive medical device can be manufactured by any method utilized to manufacture a corresponding medical device not comprising a nanocomposite.

The following examples are not intended to be limiting.

### EXAMPLE 1

Preparation of Inner Shaft Catheter Tubing with an HDPE/POSS Nanocomposite

1) Preparation of the HDPE/POSS Nanocomposite by Twin-screw Extrusion Compounding

An organically functionalized POSS (MS0830, an OctaMethyl-POSS commercially available from Hybrid Plastics, Fountain Valley, Calif.) was compounded with high density polyethylene (HDPE Marlex 4903, commercially available from Chevron-Phillips Chemical Company, Houston, Tex.). In particular, a material feed ratio of HDPE to POSS of 4:1 was fed into a counter rotating dispersive twin screw compounder ZSE 27 (commercially available from Leistritz Company, Allendale, N.J.) operating at 190° C. and a speed of 200 RPM. The compounding output was at 5 pounds per hour.

2) Extrusion of Inner Shaft Catheter Tubing Incorporating HDPE/POSS Nanocomposite Material.

A 4:1 mixture of the HDPE/POSS nanocomposite to plexar 390 anhydride modified polyethylene (commercially available from Equistar Chemical Company, Houston, Tex.) was premixed and then further diluted at a 3:1 ratio with Marlex 4903 polyethylene and extruded into tubing of dimensions of 0.018 inch×0.024 inch at 220° C. The resulting inner shaft tubing could be used in an over the wire, single operator exchange catheter, or stent delivery system, using conventional construction techniques.

### EXAMPLE 2

Preparation of Outer Shaft Catheter Tubing with a Pebax®/POSS Nanocomposite

1) Preparation of the Pebax®/POSS Nanocomnosite by Twin-screw Extrusion Compounding

An organically functionalized POSS (AM0265, an Aminopropylisobutyl-POSS commercially available from Hybrid Plastics) was compounded with Pebax® 7233 (Pebax® is a polyether block amide commercially available from Atofina, Brussels, Belgium). In particular, a material feed ratio of Pebax® to POSS of 4:1 was fed into a counter rotating dispersive Leistritz ZSE 27 twin screw compounder operating at 200° C. and a speed of 100 RPM. The compounding output was at 5 pounds per hour.

2) Extrusion of Outer Shaft Catheter Tubing Incorporating Pebax®&/POSS Nanocomposite Material

A 3:1 dilution of the Pebax®/POSS nanocomposite to Pebax® 7233 was prepared and extruded into outer shaft tubing with dimensions of 0.0306 inch×0.0362 inch at 226° C.

During the tubing extrusion process, the nanocomposite may be more stable than conventional filled Pebax®. If the tubing produced by this method were subject to an EtO sterilization, that the POSS nanofiller may reduce or substantially prevent the oriented Pebax®V chains from relaxing to a detrimental degree, as compared to such relaxation that may be expected to occur in an unfilled pebax medical device or device component when subjected to such sterilizing treatment.

### EXAMPLE 3

Preparation of Outer Shaft Catheter Tubing with a Pebax(V/Clay Nanocomposite

A Pebax®/Clay nanocomposite material said to contain 95% Pebax® 7233 and 5% Clay filler with the trade designation of 2099 X 83109 C was purchased from RTP Company (Winona, Minn.). The material was extruded into acceptable outer shaft tubing with dimensions 0.0306 inch×0.0362 inch at an extrusion temperature of 226° C.

### EXAMPLE 4

Preparation of Multilayer Tubing with a Pebax®/montmorillonite Nanocomposites

A Pebax®/montmorillonite nanocomposite material containing 95% of a 72 durometer Pebax® material (such as Pebax® 7233 commercially available from Atochem) and 5% montmorillonite filler will be compounded with a twin screw extruder as described above. The nanocomposite material will then be coextruded with non-filled Pebax® at a temperature sufficient to provide appropriate viscosity for extrusion, i.e., from about 190° C. to about 215° C., into acceptable trilayer tubing having the Pebax®/montmorillonite nanocomposite as a middle layer and non-filled Pebax® as the inner and outer layers. The trilayer tubing will have dimensions appropriate for the intended use of the tubing. If the tubing is to be used, e.g., in the formation of a balloon, dimensions may be an inner diameter of about 0.0176 inch and an outer diameter of about 0.342 inch.

### EXAMPLE 5

Preparation of Monolayer Tubing with a Pebax®/Modified Montmorillonite Nanocomposites

A Pebax®/montmorillonite nanocomposite material containing 90% of a 70 durometer Pebax® material (such as Pebax® 7033 commercially available from Atochem) and 10% modified montmorillonite filler will be compounded with a twin screw extruder as described above. Prior to compounding, the montmorillonite will be modified with a functionalizer comprising a block copolymer capable of interacting with polyether and/or polyamide, as described hereinabove. The nanocomposite material will be extruded at a temperature sufficient to provide appropriate viscosity for extrusion, e.g., from about 190° C. to about 215° C., into acceptable monolayer tubing having dimensions appropriate for the intended use of the tubing. This tubing can then be used to form balloons, the inner lumen of catheters, the outer lumen of catheters, and the like. If the tubing is to be used, e.g., in the formation of a balloon, dimensions may be an inner diameter of about 0.0176 inch and an outer diameter of about 0.342 inch.

### EXAMPLE 6

Preparation of Monolayer Tubing with a Nylon 12/Modified Montmorillonite Nanocomposites

A nylon 12/montmorillonite nanocomposite material containing 99% of a nylon 12 (commercially available under the trade name Rilsan® from Atofina) and 1% Modified montmorillonite filler will be prepared as follows. All materials will either be purchased as powders or ground into powders by any known method. The montmorillonite will be modified with a functionalizer comprising block polyamide or any material having polyamide groups, as described hereinabove. The powdered nylon 12 and powdered functionalized montmorillonite will be mixed together and fed into an extrusion process via a gravimetric feeding device (or any other acceptable powder feeding mechanism). The nanocomposite material will then be extruded at a temperature sufficient to provide appropriate viscosity for extrusion, e.g., from about 210° C. to about 240° C., such as 220° C. to 230° C., into acceptable monolayer tubing having dimensions appropriate for the intended use of the tubing. Such uses could include, e.g., formation of balloons, inner lumens of catheters, outer lumens of catheters, etc. Tubing comprising such a nanocomposite is contemplated to be particularly useful in the formation of balloons, for which use appropriate tubing dimensions are an inner diameter of about 0.0176 inch and an outer diameter of about 0.342 inch. More particular, the balloon may be formed by any known method and subsequently attached to catheter shafting by any known construction method.

### EXAMPLE 7

Preparation of Heat Bonded Multilayer Catheter Shafting Comprising a Single Walled Carbon Nanotube Tie Layer

Multilayer catheter shafting will be prepared comprising a layer of Pebax® and a layer of Plexar® (anhydride modified polyethylene commercially available from Equistar Chemical Company, Houston, Tex.), having a tie layer of single walled carbon nanotubes therebetween using an over-the-wire tandem extrusion process as follows:

Plexar® will be extruded onto a Teflon coated copper mandrel at 220° C. An aqueous solution of arabic gum and single wall carbon nanotubes (1 ml purified water, 200 mg Gum arabic, 30 mg carbon nanotubes) will then be sprayed onto the Plexar® shafting. Any excess water will be removed by running the shafting through a 120° C. oven. A second extruder in tandem will extrude a layer of Pebax® over the Plexar carbon nanotubes at a temperature of 226° C. The resulting multilayer tubing will exhibit enhanced bond strength between the layers due to the embedment of the carbon nanotubes at the interface layer.

### EXAMPLE 8

Effect of Different Functionalizers on Performance and Properties of Pebax®/Clay Nanocomposites

Three nanocomposites were prepared comprising 95% Pebax® 7233 and 5% clay.

More particularly, a first such nanocomposite comprising unmodified clay, a second such nanocomposite comprising clay modified with a block copolymer having hydroxyl end groups and a third such nanocomposite comprising clay modified with a block copolymer having carboxylic end groups, were separately compounded with a twin screw extruder as described above. The material was extruded into tubing and tested on an Instron. The elongation at break (epsilon), elasticity modulus (E) as well as the ultimate strength (sigma) were measured. The results are provided below in Table 1:

TABLE 1

| | E(N/mm²) | Sigma (N) | Epsilon % |
|---|---|---|---|
| Unmodified clay/Pebax | 576.7 | 41.0666 | 128.94 |
| nanocomposite | | | |
| ROH modified clay/Pebax | 669.3 | 42.96667 | 200.8667 |
| nanocomposite | | | |
| RCOOH modified clay/Pebax | 650.1 | 44.225 | 152.755 |
| nanocomposite | | | |

As is shown, the properties of the modified clay nanocomposites vary significantly. In order to take advantage of this variation, for example, the ROH modified clay/Pebax nanocomposite could be used as an outer layer for a balloon, thereby obtaining an increase of approximately greater than 50%, typically greater than 40%, for example greater than 25%, in puncture resistance due to the increase in epsilon. If the RCOOH modified clay/Pebax nanocomposite were then utilized as an inner layer of the same balloon, the burst resistance ay be increased as a result of the measured increase in overall strength that was seen in this nanocomposite relative to a nanocomposite comprising an unmodified clay.

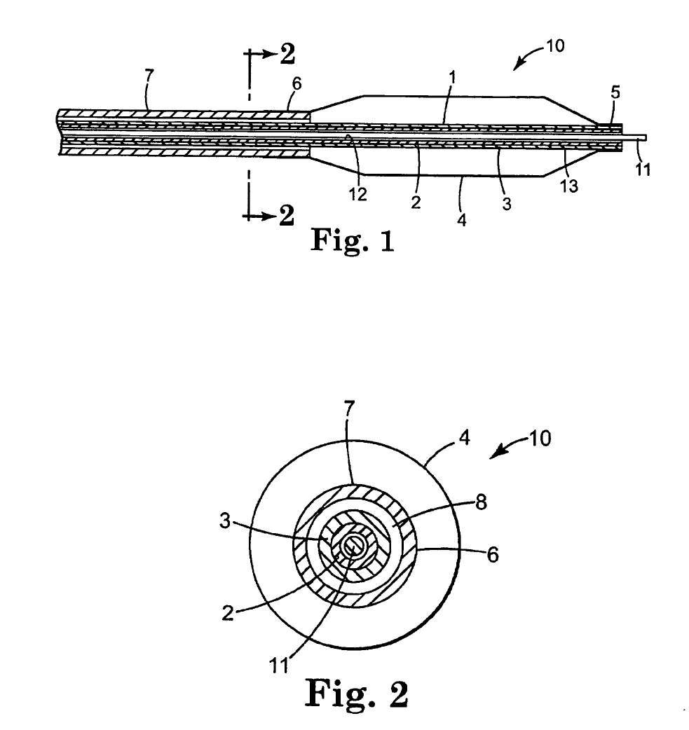

Referring now to FIGS. 1 and 2, there is illustrated an embodiment of a medical device. In particular, FIG. 1 is a longitudinal cross-section view of the distal end of a balloon angioplasty catheter 10. In this embodiment, catheter 10 includes an inner tubular component 1 comprising an inner layer 2 and outer layer 3. A balloon 4 having a distal waist 5 is attached to inner tubular component 1. Balloon 4 also has a proximal waist 6 attached to outer tubular component 7. A guidewire 11 is shown within lumen 12 of inner tubular member 1. FIG. 2 is a transverse cross-section view taken at line 2-2 of FIG. 1.

Inner tubular component 1, inner layer 2, outer layer 3, balloon 4, or outer tubular component 7, or guidewire 11, can be prepared in whole or in part from a nanocomposite material as disclosed herein. In addition, any of these components can be single layer or multiple layer with one or more of the layers comprising a nanocomposite. Thus, for example, in FIGS. 1 and 2, inner tubular component 1 is illustrated with multiple layers wherein, either or both of layers 2 and 3 of inner tubular component 1 can be prepared from a nanocomposite material. Thus, for example, either of layers 2 or 3 can comprise a nanocomposite material prepared as described in Examples 1-3 above.

Also as disclosed earlier, a stent delivery system including the stent mounted over balloon 4 can be prepared. In addition, components known in the art for use with balloon expandable stent delivery systems, such as sleeves, disclosed for example in U.S. Pat. No. 4,950,227 can be used. Based on this disclosure, it will be appreciated that self-expanding stent delivery systems, guide catheters, angiography catheters, etc. can also be prepared.

Other embodiments are within the following claims.

What is claimed is:

1. A medical device, comprising:
a component comprising a composite comprising a matrix material and particles comprising molybdenum and sulfur.

2. The medical device of claim 1, wherein the particles are nanotubes.

3. The medical device of claim 1, wherein the particles comprise MoS₂.

4. The medical device of claim 1, wherein the particles further comprise iodine.

5. The medical device of claim 4, wherein the particles are solid nanowires.

6. The medical device of claim 4, wherein the particles comprise a material selected from the group consisting of Mo₆S₃I₆, MoS₂I_{1/3}, and Mo₆S₄I₆.

7. The medical device of claim 4, wherein the particles comprise solid nanowires comprising Mo₆S₃I₆.

8. The medical device of claim 1, wherein the composite further comprises a functionalizer, a compatibilizer, a dispersant, or a combination thereof.

9. The medical device of claim 1, wherein the device is a transluminal medical device.

10. The medical device of claim 1, wherein the component comprises multiple layers, and at least one of the layers comprises the composite.

11. The medical device of claim 10, wherein at least one of the layers is free of particles.

12. The medical device of claim 10, wherein the component comprises layers having different particles.

13. The medical device of claim 1, wherein the composite further comprises nanoparticles different than the particles.

14. The medical device of claim 1, wherein the matrix material comprises a thermoset material.

15. The medical device of claim 14, wherein the thermoset material comprises a nitrile butadiene elastomer, a silicone, an epoxy, a isocyanate, EPDM, epichlorohydrin, or a copolymer, a block copolymer or a polymer blend thereof.

16. The medical device of claim 1, wherein the matrix material comprises a thermoplastic material.

17. The medical device of claim 16, wherein the thermoplastic material comprises a polyolefin, a polyamide, a polyester, a polyether, a polyether amide block copolymer, a polyurethane, a polyurea, a polyvinyl, a polyacrylic, a fluoropolymer or a copolymer, a block copolymer or a blend thereof

18. The medical device of claim 1, wherein the component comprises a catheter shaft.

19. The medical device of claim 1, wherein the component comprises a balloon.

20. The medical device of claim 1, wherein the device is a guide catheter.
